(19) United States
(12) Patent Application Publication
(10) Pub. No.: US 2018/0337391 A1
(43) Pub. Date: Nov. 22, 2018

(54) PRESSING PROCESS OF CREATING A PATTERNED SURFACE ON BATTERY ELECTRODES

(71) Applicant: GM Global Technology Operations LLC, Detroit, MI (US)

(72) Inventors: Zhiqiang Yu, Shanghai (CN); Meiyuan Wu, Shanghai (CN); Jim Gu, Shanghai (CN); Xiaochao Que, Shanghai (CN)

(73) Assignee: GM Global Technology Operations LLC, Detroit, MI (US)

(21) Appl. No.: 15/598,930

(22) Filed: May 18, 2017

(51) Int. Cl. H01M 4/04; H01M 10/0525

(52) U.S. Cl. CPC H01M 4/0435; H01M 4/0404; H01M 10/0525

(57) ABSTRACT

A method of making a patterned electrode material is provided. The method includes disposing a first mask having a first pattern on a first surface of an electrode material, disposing a second mask having a second pattern on an opposing second surface of the electrode material, applying pressure through both the first mask and the second mask towards the electrode material, wherein the first pattern of the first mask is engraved into the first surface of the electrode material and the second pattern of the second mask is engraved into the second surface of the electrode material, and removing the first mask and the second mask form the electrode material to from the patterned electrode material.

### INTRODUCTION

This section provides background information related to the present disclosure which is not necessarily prior art.

The present disclosure relates to methods of creating patterns on electrode surfaces to improve power performance by increasing electrode surface area and the amount of stored electrolyte.

High-energy density, electrochemical cells, such as lithium ion batteries can be used in a variety of consumer products and vehicles, such as Hybrid Electric Vehicles (HEVs) and Electric Vehicles (EVs). Typical lithium ion batteries comprise a first electrode (e.g., a cathode), a second electrode (e.g., an anode), an electrolyte material, and a separator. Often a stack of lithium ion battery cells are electrically connected to increase overall output. Lithium ion batteries operate by reversibly passing lithium ions between the negative electrode and the positive electrode. A separator and an electrolyte are disposed between the negative and positive electrodes. The electrolyte is suitable for conducting lithium ions and may be in solid or liquid form. Lithium ions move from a cathode (positive electrode) to an anode (negative electrode) during charging of the battery, and in the opposite direction when discharging the battery.

Contact of the anode and cathode materials with the electrolyte can create an electrical potential between the electrodes. When electron current is generated in an external circuit between the electrodes, the potential is sustained by electrochemical reactions within the cells of the battery. Each of the negative and positive electrodes within a stack is connected to a current collector (typically a metal, such as copper for the anode and aluminum for the cathode). During battery usage, the current collectors associated with the two electrodes are connected by an external circuit that allows current generated by electrons to pass between the electrodes to compensate for transport of lithium ions.

Many different materials may be used to create components for a lithium ion battery. By way of non-limiting example, cathode materials for lithium batteries typically comprise an electroactive material which can be intercalated with lithium ions, such as lithium-transition metal oxides or mixed oxides of the spinel type, for example including spinel LiMn₂O₄, LiCoO₂, LiNiO₂, LiMn_{1.5}Ni_{0.5}O₄, LiNi_{(1-x-y)}CoₓM_{y}O₂ (where 0<x<1, y<1, and M may be Al, Mn, or the like), or lithium iron phosphates. The electrolyte typically contains one or more lithium salts, which may be dissolved and ionized in a non-aqueous solvent.

The negative electrode typically includes a lithium insertion material or an alloy host material. Typical electroactive materials for forming an anode include lithium-graphite intercalation compounds, lithium-silicon intercalation compounds, lithium-tin intercalation compounds, lithium alloys. While graphite compounds are most common, recently, anode materials with high specific capacity (in comparison with graphite) are of growing interest. For example, silicon has the highest known theoretical charge capacity for lithium, making it one of the most promising materials for rechargeable lithium ion batteries.

It would be desirable to develop high performance electrodes for batteries by increasing electrode surface area without major modifications to existing battery fabrication processes.

### SUMMARY

This section provides a general summary of the disclosure, and is not a comprehensive disclosure of its full scope or all of its features.

In various aspects, the current technology provides an exemplary method of making a patterned electrode material. The method includes disposing a first mask having a first pattern on a first surface of an electrode material, disposing a second mask having a second pattern on an opposing second surface of the electrode material, applying pressure through both the first mask and the second mask towards the electrode material, wherein the first pattern of the first mask is engraved into the first surface of the electrode material and the second pattern of the second mask is engraved into the second surface of the electrode material, and removing the first mask and the second mask from the electrode material to form the patterned electrode material.

In one variation, the first mask and the second mask individually include a plurality of wires that defines at least one of the first pattern and the second pattern or a mesh sheet that defines at least one of the first pattern and the second pattern.

In one variation, each wire in the plurality of wires is spaced substantially parallel to each other at a length of greater than or equal to about 0.05 mm to less than or equal to about 2 mm.

In one variation, each wire in the plurality of wires is cylindrical and have a diameter of greater than or equal to about 5 μm to less than or equal to about 200 μm.

In one variation, the mesh sheet defines a repeating pattern of squares, rectangles, triangles, diamonds, or combinations thereof.

In one variation, the first mask and the second mask individually include (Cu), aluminum (Al), iron (Fe), nickel (Ni), titanium (Ti), platinum (Pt), palladium (Pd), an alloy, or combinations thereof.

In one variation, the at least one of the first mask and the second mask is coated with a polymer or a ceramic.

In one variation, the applying pressure is performed by pressing both the first and second masks into the electrode material between cylindrical calenders of a roll press or between plates of a flat press.

In one variation, the method further includes heating at least one of the electrode material and either the cylindrical calenders or the plates.

In one variation, an electrochemical cell including a patterned electrode material made according to the method of claim 1 is provided.

In other aspects, the current technology provides an exemplary method of making a patterned electrode material. The method includes contacting a first surface of an electrode material with a first surface of a first pressing element of a flat press or roll press, wherein the first surface of the first pressing element defines a first concave or convex pattern, contacting a second opposing surface of the electrode material with a second surface of a second pressing element of the flat press or roll press, wherein the second surface of the second pressing element defines a second concave or convex pattern, applying pressure to the electrode material through both the first and second pressing elements, wherein the first and second concave or convex patterns are transferred to the first and second surfaces of the electrode material as a negative and form the patterned electrode material, and removing the patterned electrode material from the pressing elements.

In one variation, the first and second pressing elements are flat pressing plates of a flat press or cylindrical pressing rolls of a roll press.

In one variation, the contacting a first surface of an electrode material with a first surface of a first pressing element, the contacting a second opposing surface of the electrode material with a second surface of a second pressing element, and the applying pressure are performed substantially concurrently.

In one variation, the first and second concave or convex patterns are individually a plurality of substantially parallel stripes or a grid of interconnecting lines that define a repeating geometric pattern between the lines, wherein the repeating geometric pattern includes squares, rectangles, triangles, diamonds, or combinations thereof.

In one variation, the method further includes heating at least one of the electrode material, the first surface of the first pressing element, and the second surface of the second pressing element.

In yet other aspects, the current technology provides an exemplary method of making a patterned electrode material. The method includes disposing a first surface of an electrode material on a support cushion, contacting a plurality of needles arranged in a pattern to an opposing second surface of the electrode material, applying pressure to the plurality of needles, wherein the plurality of needles passes at least partially through the electrode material, and removing the plurality of needles from the electrode material to form a patterned electrode material having a plurality of apertures that extends from the second surface and at least partially through the electrode material towards the opposing first surface.

In one variation, the needles pass partially through the electrode material to form a first plurality of apertures, and the method further includes disposing the second surface of the electrode material on the support cushion, contacting the plurality of needles to the first surface of the electrode material, applying pressure to the plurality of needles, wherein the plurality of needles passes partially through the electrode material, and removing the plurality of needles to form the patterned electrode having a second plurality of apertures that extends from the first surface and partially through the electrode material toward the second surface, wherein the first plurality of apertures does not communicate with the second plurality of apertures.

In one variation, the support cushion includes glass, plastic, ceramic, metal, or a combination thereof.

In one variation, the plurality of needles is coupled to a press plate, each needle of the plurality has a diameter of from greater than or equal to about 5 μm to less than or equal to about 100 μm, is spaced apart from each other by greater than or equal to about 0.1 mm to less than or equal to about 2 mm, and includes (Cu), aluminum (Al), iron (Fe), nickel (Ni), titanium (Ti), platinum (Pt), palladium (Pd), an alloy, or combinations thereof.

In one variation, the method further includes removing electrode material debris from the electrode material, and flattening the patterned electrode material by passing the patterned electrode material through a roll press.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic of an exemplary electrochemical battery cell.

FIG. 2A is a schematic of a method of making a patterned electrode material with a first mask type according to various aspects of the current technology.

FIG. 2B is a schematic of a method of making a patterned electrode material with a second mask type according to various aspects of the current technology.

FIG. 2C is a cross-sectional schematic of a patterned electrode material made by the first method.

FIG. 3A is a photograph of a patterned electrode material.

FIG. 3B is a first computer-generated image of the patterned electrode material shown in FIG. 3A.

FIG. 3C is a second computer-generated image of the patterned electrode material shown in FIG. 3A.

FIG. 3D is a first electron micrograph of the pattered electrode material shown in FIG. 3A.

FIG. 3E is a second electron micrograph of the pattered electrode material shown in FIG. 3A.

FIG. 4A is a schematic of a flat press adapted to various aspects of the current technology.

FIG. 4B is a schematic of a roll press adapted to various aspects of the current technology.

FIG. 4C is a patterned electrode material made with the flat press of FIG. 4A or the roll press of FIG. 4B.

FIG. 5A is a schematic of a pressing element having a pattern comprising convex stripes.

FIG. 5B is a schematic of a pressing element having a pattern comprising a convex grid.

FIG. 6A is a schematic of a pressing element having a pattern comprising concave stripes.

FIG. 6B is a schematic of a pressing element having a pattern comprising a concave grid.

FIG. 7 is a schematic of a pressing element having a pattern comprising wires disposed in concave grooves.

FIG. 8A is a schematic of a system for making a patterned electrode material.

FIG. 8B is a cross section schematic of an electrode material being pierced by a plurality of needles.

FIG. 8C is a schematic of a patterned electrode material made by the system of FIG. 8A.

FIG. 8D is a perspective view of the patterned electrode material shown in FIG. 8C.

FIG. 8E is a cross-sectional view of the patterned electrode material shown in FIG. 8C.

FIG. 9A is a schematic of an exemplary patterned electrode material made according to various aspects of the current technology.

FIG. 9B is cross sectional view of an exemplary patterned electrode material made according to various aspects of the current technology.

FIG. 9C is cross sectional view of an exemplary patterned electrode material made according to various aspects of the current technology.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges. As referred to herein, ranges are, unless specified otherwise, inclusive of endpoints and include disclosure of all distinct values and further divided ranges within the entire range. Thus, for example, a range of “from A to B” or “from about A to about B” is inclusive of A and B.

Example embodiments will now be described more fully with reference to the accompanying drawings.

The current technology provides patterned electrode materials that are suitable for electrochemical cells and capacitors. The patterns are convex or concave and, relative to electrode materials without patterns, increase the surface area of the electrode materials, provide increased ion diffusion, and increase electrolyte distribution, all of which improves battery power performance. Moreover, the following methods of making such patterned electrode materials without major modifications to many existing battery fabrication processes and do not introduce contaminations. The methods can be performed on a sheet of electrode material, which is then cut to an appropriate size for an electrochemical cell or capacitor or on pre-cut electrode materials.

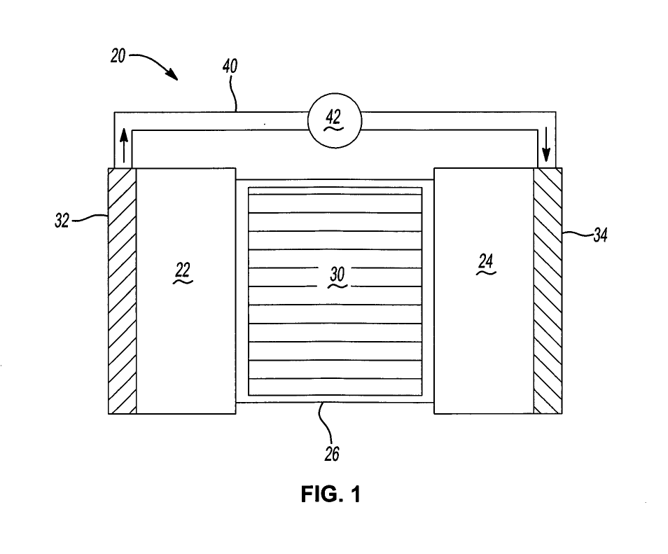

In various aspects, the patterned electrode according to certain aspects of the present disclosure can be used as either a positive electrode or a negative electrode for an electrochemical cell, such as an electrochemical cell that cycles lithium ions (e.g., a lithium ion battery, a lithium primary battery, a lithium sulfur battery,) or an electrochemical cell that cycles sodium ions (e.g., a sodium ion battery, a sodium primary battery, a sodium sulfur battery), or a capacitor. Accordingly, FIG. 1 provides an exemplary schematic illustration of a lithium ion battery 20. Lithium ion battery 20 includes a negative electrode 22, a negative current collector 32 in contact with the negative electrode 22, a positive electrode 24, a positive current collector 34 in contact with the positive electrode 24, and a separator 26 disposed between the negative and positive electrodes 22, 24. The negative electrode 22 may be referred to herein as an anode and the positive electrode 24 as a cathode. In certain instances, each of the negative current collector 32, negative electrode 22, the separator 26, positive electrode 24, and positive current collector 34 may be assembled in layers connected in electrical parallel arrangement to provide a suitable energy package.

The negative electrode 22 includes an electroactive material as a lithium host material capable of functioning as a negative terminal of a lithium ion battery. For example only, the electroactive material may comprise a compound comprising carbon (C; such as graphite), silicon (Si), tin (Sn), germanium (Ge), bismuth (Bi), zinc (Zn), tellurium (Te), lead (Pb), gallium (Ga), aluminum (Al), arsenic (As), lithium (Li), lithium titanium (Li₄Ti₅O₁₂), or combinations thereof. In certain instances, the negative electrode 22 may further include a polymeric binder material to structurally fortify the electroactive material.

A negative electrode current collector 32 may be positioned at or near the negative electrode 22. The current collector 32 may comprise a relatively ductile metal or metal alloy that is electrically conductive. The current collector 32 may include a compound selected from the group consisting of: gold (Au), lead (Pb), niobium (Nb), palladium (Pd), platinum (Pt), silver (Ag), vanadium (V), tin (Sn), aluminum (Al), copper (Cu), tantalum (Ta), nickel (Ni), iron (Fe), and combinations thereof.

The separator 26 positioned between the negative electrode 22 and the positive electrode 24 may operate as both an electrical insulator and a mechanical support, preventing physical contact and, consequently, the occurrence of a short circuit. Further, the separator 26, in addition to providing a physical barrier between the two electrodes 22, 24, may provide a minimal resistance path for internal passage of lithium ions (and related anions) for facilitating functioning of the lithium ion battery 20.

The separator 30 may comprise a microporous polymeric separator including a polyolefin. The polyolefin may be a homopolymer (e.g., derived from a single monomer constituent) or a heteropolymer (e.g., derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. For example only, the polyolefin may be polyethylene (PE), polypropylene (PP), or a combination thereof.

The separator 30, as a microporous polymeric separator, may be a single layer or a multi-layer laminate, which may be fabricated from either a dry or wet process. In certain instances, a single layer of the polyolefin may form the entire microporous polymer separator 30. In other instances, the separator 30 may be a fibrous membrane having an abundance of pores extending between the opposing surfaces and may have a thickness of less than a millimeter. In still other instances, multiple discrete layers of similar or dissimilar polyolefins may be assembled to form the microporous polymer separator 30. The microporous polymer separator 30 may include other polymers in addition to the polyolefin. For example only, the separator 30 may also include polyethylene terephthalate (PET), polyvinylidene fluoride (PVDF), and/or a polyamide. The polyolefin layer and any other optional polymer layers may be included in the microporous polymer separator 30 as a fibrous layer and may provide the microporous polymer separator 30 with appropriate structural and porosity characteristics.

The separator 26 may include an electrolyte 30 in solid or solution form that is capable of conducting lithium ions. The electrolyte 30 may also be present in the negative electrode 22 and positive electrode 24. In certain instances, the electrolyte 30 may be a non-aqueous liquid electrolyte solution that includes a lithium salt dissolved in an organic solvent or a mixture of organic solvents. For example only, the lithium salt may be selected from the group consisting of lithium hexafluorophosphate (LiPF₆); lithium perchlorate (LiClO₄); lithium tetrachloroaluminate (LiAlCl₄); lithium iodide (LiI); lithium bromide (LiBr); lithium thiocyanate (LiSCN); lithium tetrafluoroborate (LiBF₄); lithium tetraphenylborate (LiB(C₆H₅)₄); lithium hexafluoroarsenate (LiAsF₆); lithium trifluoromethanesulfonate (LiCF₃SO₃); bis(trifluoromethane)sulfonimide lithium salt (LiN(CF₃SO₂)₂); and combinations thereof. The organic solvent(s) may be selected from the group consisting of: cyclic carbonates (e.g., ethylene carbonate (EC), propylene carbonate (PC), butylene carbonate (BC)); acyclic carbonates (e.g., dimethyl carbonate (DMC), diethyl carbonate (DEC), ethylmethylcarbonate (EMC)); aliphatic carboxylic esters (e.g., methyl formate, methyl acetate, methyl propionate); γ-lactones (e.g., γ-butyrolactone, γ-valerolactone); chain structure ethers (e.g., 1,2-dimethoxyethane, 1-2-diethoxyethane, ethoxymethoxyethane); cyclic ethers (e.g., tetrahydrofuran, 2-methyltetrahydrofuran); and combinations thereof.

The positive electrode 24 may be formed from a lithium-based active material that can sufficiently undergo lithium intercalation/alloy and deintercalation/dealloyintercalation/alloy while functioning as the positive terminal of the lithium ion battery 20. In certain instances, layered lithium transitional metal oxides may be used to form the positive electrode 24. For example only, the positive electrode 24 may comprise a lithium manganese oxide (Li₍₁₊ₓ₎Mn₍₂₋ₓ₎O₄), where 0≤x≤1 (e.g., LiMn₂O₄); a lithium manganese nickel oxide (LiMn₍₂₋ₓ₎NiₓO₄), where 0≤x≤1 (e.g., LiMn_{1.5}Ni_{0.5}O₄); lithium cobalt oxide (LiCoO₂); lithium manganese oxide (LiMn₂O₄); lithium nickel oxide (LiNiO₂); a lithium nickel manganese cobalt oxide (Li(NiₓMn_{y}Co_{z})O₂), where 0≤x≤1, 0≤y≤1, 0≤z≤1, and x+y+z=1 (e.g., LiMn_{0.33}Ni_{0.33}Co_{0.33}O₂); a lithium nickel cobalt metal oxide (LiNi_{(1-x-y)}CoₓM_{y}O₂), where 0<x<1, y<1 and M may be Al, Mn, or the like; mixed oxides lithium iron phosphates; or a lithium iron polyanion oxide (e.g., lithium iron phosphate (LiFePO₄) or lithium iron fluorophosphate (Li₂FePO₄F)). In certain instances, the positive electrode 24 may further include a polymeric binder material to structurally fortify the lithium-based active material and/or conductive additives to improve electrode conductivity, wherein non-limiting examples of conductive additives include conductive carbon, graphite, vapor growth carbon fiber, graphene, carbon nanotubes, and combinations thereof. In certain instances, the active materials of the positive electrode 24 may be intermingled with at least one polymeric binder by slurry casting active materials with such binders.

A positive electrode current collector 34 may be positioned at or near the positive electrode 24. The current collector 34 may comprise a relatively ductile metal or metal alloy that is electrically conductive. The current collector 34 may include a compound selected from the group consisting of: gold (Au), lead (Pb), niobium (Nb), palladium (Pd), platinum (Pt), silver (Ag), vanadium (V), tin (Sn), aluminum (Al), copper (Cu), tantalum (Ta), nickel (Ni), iron (Fe), and combinations thereof.

The negative electrode current collector 32 and positive electrode current collector 34 may respectively collect and move free electrons to and from an external circuit 40. The external circuit 40 and load 42 may connect the negative electrode 22 through its current collector 32 and the positive electrode 24 through its current collector 34. The lithium ion battery 20 may generate an electric current during discharge by way of reversible electrochemical reactions that occur when the external circuit 40 is closed (e.g., the negative electrode 22 is connected to the positive electrode 34) and the negative electrode 22 contains a greater relative quantity of intercalated lithium. The chemical potential difference between the positive electrode 24 and the negative electrode 22 may drive electrons produced by the oxidation of intercalated lithium at the negative electrode 22 through the external circuit 40 toward the positive electrode 24. Lithium ions, which may also be produced at the negative electrode, may be concurrently transferred through the electrolyte 30 and separator 26 towards the positive electrode 24. The electrons may flow through the external circuit 40 and the lithium ions migrate across the separator 26 in the electrolyte 30 to form intercalated lithium at the positive electrode 24. The electric current passing through the external circuit 40 may be harnessed and directed through the load device 42 until the intercalated lithium in the negative electrode 22 is depleted and the capacity of the lithium ion battery 20 diminished.

The lithium ion battery 20 may be charged or re-powered at any time by connecting an external power source to the lithium ion battery 20 to reverse the electrochemical reactions that occur during battery discharge. The connection of an external power source to the lithium ion battery 20 may facilitate the otherwise non-spontaneous oxidation of intercalated lithium at the positive electrode 24 to produce electrons and lithium ions. The electrons, which may flow back towards the negative electrode 22 through the external circuit 40, and the lithium ions, which may be carried by the electrolyte 30 across the separator 26 back towards the negative electrode 22, may reunite at the negative electrode 22 and replenish the negative electrode 22 with intercalated lithium for consumption during the next battery 20 discharge cycle. The external power source that may be used to charge the lithium ion battery 20 may vary depending on the size, construction, and particular end-use of the lithium ion battery 20. For example only, the external power source may be an AC wall outlet or a motor vehicle alternator.

The size and shape of the lithium ion battery 20 may vary depending on the particular application for which it is designed. In certain instances, the lithium ion battery 20 may also be connected in series or parallel with other similar lithium ion cells or batteries to produce a greater voltage output and power density if it is required by the load device 42. The load device 42 may be powered fully or partially by the electric current passing through the external circuit 40 when the lithium ion battery 20 is discharging. For example only, the load device 42 may be an electric motor for a hybrid vehicle or an all-electrical vehicle, a laptop computer, a tablet computer, a cellular phone, or a cordless power tool or appliance. In certain instances, the load device 42 may be a power-generating apparatus that charges the lithium ion battery 20 for purposes of storing energy.

The electroactive material comprising the negative electrode 22 and/or the active material comprising the positive electrode 24, collectively referred to as an “electrode material,” may be modified to improve power performance by including a concave or convex pattern that increases surface area and increases the amount of electrolyte 30 stored in the battery 20. An electrode material may be modified to include the convex or concave pattern by the methods of the current technology.

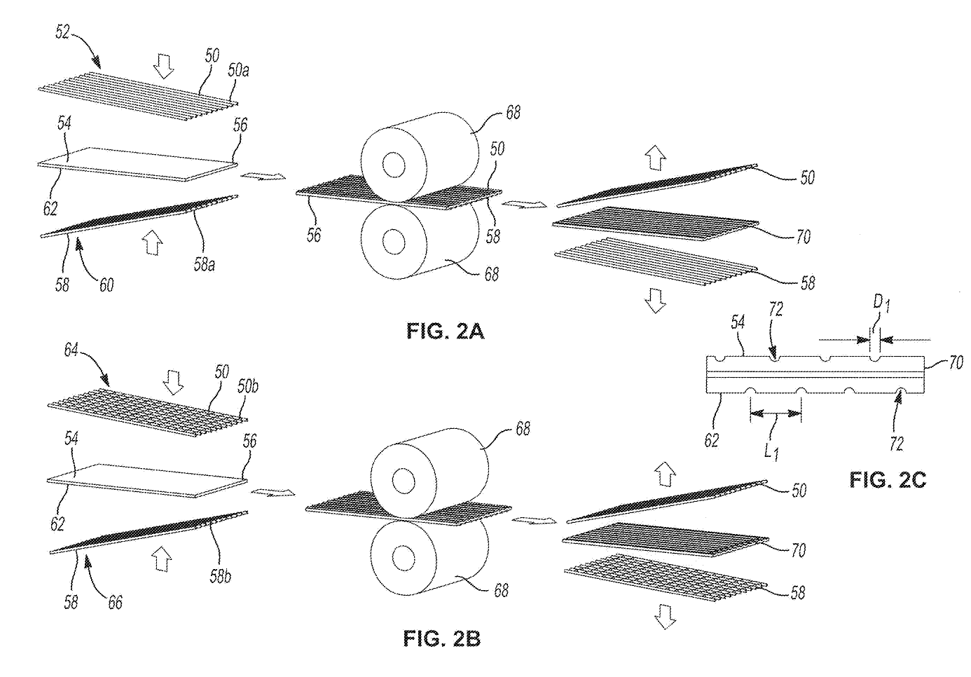

The current technology provides a first method of making a patterned electrode material. The patterned electrode material can be any electroactive material that will form a cathode or an anode in an electrochemical cell or capacitor. As shown in FIG. 2A, the method comprises disposing a first mask 50 comprising a first convex, i.e., elevated or raised, pattern 52 on a first surface 54 of an electrode material 56, and disposing a second mask 58 comprising a second convex pattern 60 on an opposing second surface 62 of the electrode material 56. As shown in FIG. 2A, first mask 50a and second mask 58a comprise a plurality of wires that defines the first pattern 52 and the second pattern 60. In various aspects of the current technology, each wire in the plurality of wires is spaced substantially parallel to each other by a length L₁ (see FIG. 2C) of greater than or equal to about 0.05 mm to less than or equal to about 2 mm. As used herein, the term “substantially parallel” means that the wires, if extended long enough, would touch to define an angle of less than or equal to about 20°, less than or equal to about 15°, less than or equal to about 10°, less than or equal to about 5°, less than or equal to about 2.5°, or less than or equal to about 1°. Moreover, each wire in the plurality of wires is cylindrical and have a diameter D₁ (see FIG. 2C) of greater than or equal to about 2 μm to less than or equal to about 200 μm, or greater than or equal to about 5 μm to less than or equal to about 100 μm, and comprise (Cu), aluminum (Al), iron (Fe), nickel (Ni), titanium (Ti), platinum (Pt), palladium (Pd), an alloy, or a combination thereof.

The method shown in FIG. 2B is similar to FIG. 2A, but first mask 50b and second mask 58b comprise a mesh sheet having a mesh that defines a first mesh pattern 64 and a second mesh pattern 66, respectively. The mesh of the first and second mesh masks 50b, 58b defines a repeating pattern of squares, rectangles, triangles, diamonds, or combinations thereof and comprise (Cu), aluminum (Al), iron (Fe), nickel (Ni), titanium (Ti), platinum (Pt), palladium (Pd), an alloy, or a combination thereof.

In various aspects of the current technology, the first mask 50 and the second mask 58 individually comprise a plurality of wires as in the first mask 50a and the second mask 58a or a mesh sheet as in the first mask 50b and the second mask 58b. There the first and second masks 50, 58 may be the same or substantially the same, i.e., contain only minor variations, or different.

Moreover, the first and second masks 50, 58 may individually be coated with a polymer or a ceramic. Non-limiting examples of suitable polymers include polyesters (including polyethylene terephthalate (PET)), polyurethane, polyolefin, poly(acrylic acid) (PAA), poly(methyl acrylate) (PMA), poly(methyl methacrylate) (PMMA), acrylonitrile butadiene styrene (ABS), polyamides (including polycaprolactam (nylon)), polylactic acid (PLA), polybenzimidazole, polycarbonate, polyether sulfone (PES), polyetherether ketone (PEEK), polyetherimide (PEI), polyethylene (PE; including ultra-high molecular weight polyethylene (UHMWPE), medium-density polyethylene (MDPE), low-density polyethylene (LDPE), and cross-lined polyethylene (PEX)), polyphenylene oxide (PPO), polyphenylene sulfide (PPS), polypropylene (PP), polystyrene (PS), polyvinyl chloride (PVC), polytetrafluoroethylene (PTFE), co-polymers thereof, and combinations thereof. Suitable ceramics include oxides, carbides, nitrides, phosphates, or carbonates. Non-limiting examples of ceramic oxides include SiO₂, Al₂O₃, B₂O₃, CaO, K₂O, Na₂O, MgO, Fe₂O₃, FeO, Fe₃O₄, ZnO, TiO₂, ZrO₂, BaO, Li₂O, PbO, SrO, and combinations thereof, non-limiting examples of ceramic carbides include SiC, CaC₂, Mo₂C, B₄C, Al₄C₃, WC, ZrC, VC, TiC, and combinations thereof, non-limiting examples of ceramic nitrides include AlN, BN, Ba₃N₂, Si₃N₄, Ti₂CN, Ca₃N₂, GaN, Ge₃N₄, InN, Li₃N, Mg₃N₂, Sr₃N₂, TiN, ZrN, and combinations thereof, non-limiting examples of ceramic phosphates include Ca₂P₂O₇.xH₂O, Ca₃(PO₄)₂, KH₂PO₄, NaH₂PO₄, ZrP, Fe(H₂PO₄)₂, FeH(HPO₄)₂, FePO₄, and combinations thereof, and non-limiting examples of ceramic carbonates include BaCO₃, CoCO₃, CaCO₃, CuCO₃, Li₂CO₃, Na₂CO₃, MgCO₃, SrCO₃, NiCO₃, K₂CO₃, and combinations thereof.

The method also comprises applying pressure through the first mask 50 and the second mask 58 towards the electrode material 56, i.e., in the direction of the block arrows pointing toward each other, wherein the first pattern 52, 64 of the first mask 50 is engraved into the first surface 54 of the electrode material 56 and the second pattern 60, 66 of the second mask 58 is engraved into the second surface 62 of the electrode material 56. The applying pressure is performed by pressing both the first and second masks 50, 58 into the electrode material 56 between cylindrical calenders (or rollers) 68 of a roll press (in the direction of the forward block arrows) or between planar plates of a flat press (not shown). The amount of pressure applied should be sufficient to engrave the first pattern 52, 64 of the first mask 50 into the first surface 54 of the electrode material 56 and the second pattern 60, 66 of the second mask 58 into the second surface 62 of the electrode material 56 without damaging the electrode material 56. However, it is understood that the more pressure that is applied, the deeper the engraving will be. In various aspects of the current technology, greater than or equal to about 4000 psi to less than or equal to about 30,000 psi of pressure is applied.

In various aspects of the current technology, the method includes heating at least one of the electrode material 56, the first mask 50, the second mask 58, and either the cylindrical calenders 68 or planar plates to help facilitate engraving the patterns 52, 60, 64, 66 into the electrode material 56. Heating can be performed, for example, at a temperature of greater than or equal to about 50° C. to less than or equal to about 140° C., and is dependent on the electrode material 56 and the composition of the first and second masks 50, 58.

The method then includes removing the first mask 50 and the second mask 58 from the electrode material 56 (as shown by the opposing block arrows) to form the patterned electrode material 70. As shown FIG. 2C, which is a cross-sectional illustration of the patterned electrode material 70, the patterned electrode material 70 comprises an engraving in the first surface 54 that is a three dimensional negative of the first pattern 52, 64 and an engraving in the second surface 62 that is a three dimensional negative of the second pattern 60, 66. Put another way, the patterned electrode material 70 comprises a plurality of grooves 72 that correspond to the first and second masks 50, 58.

Although not shown in FIGS. 2A-2C, the method may optionally include disposing only a single mask onto a surface of the electrode material, such that after applying pressure to the single mask and the electrode material, a patterned electrode material is generated with an engraved pattern on only one surface.

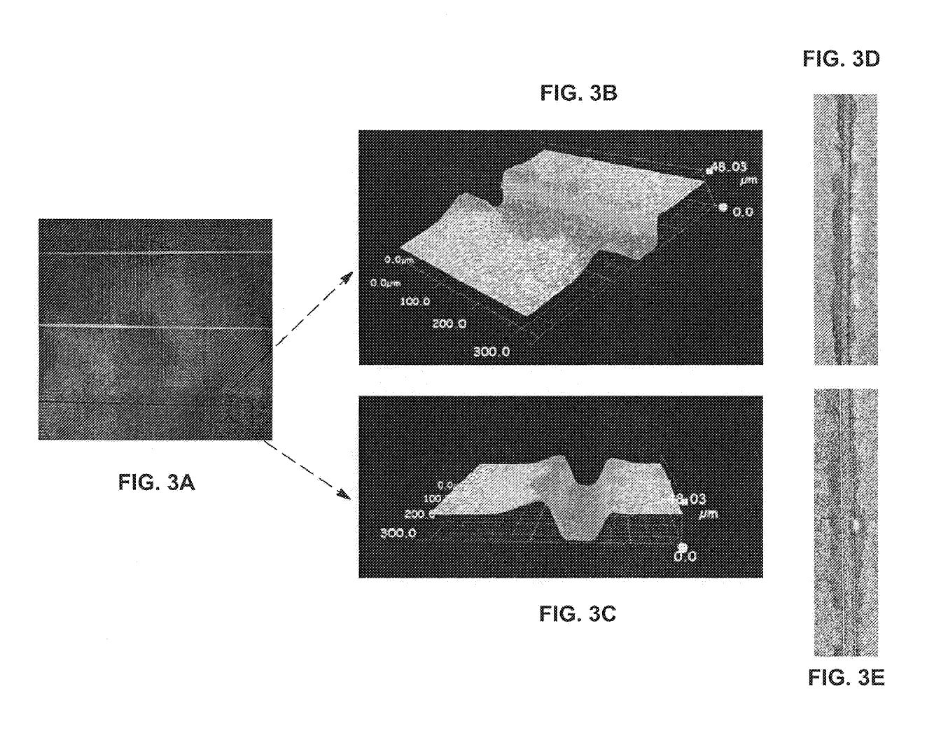

FIGS. 3A-3E show an exemplary electrode material made by the current method. More particularly, FIG. 3A shows two 40 μm copper wires (top two lines) that were pressed into a surface of an electrode material and one groove that was exposed after a third 40 μm copper wire (bottom line) was removed from the electrode material after being pressed. FIGS. 3B and 3C are computer generated topological views of the groove shown in FIG. 3A. FIGS. 3D and 3E are electron micrographs of the groove generated in the electrode material shown in FIG. 3A. These images demonstrate the increased surface area that is generated in electrode materials by the current method.

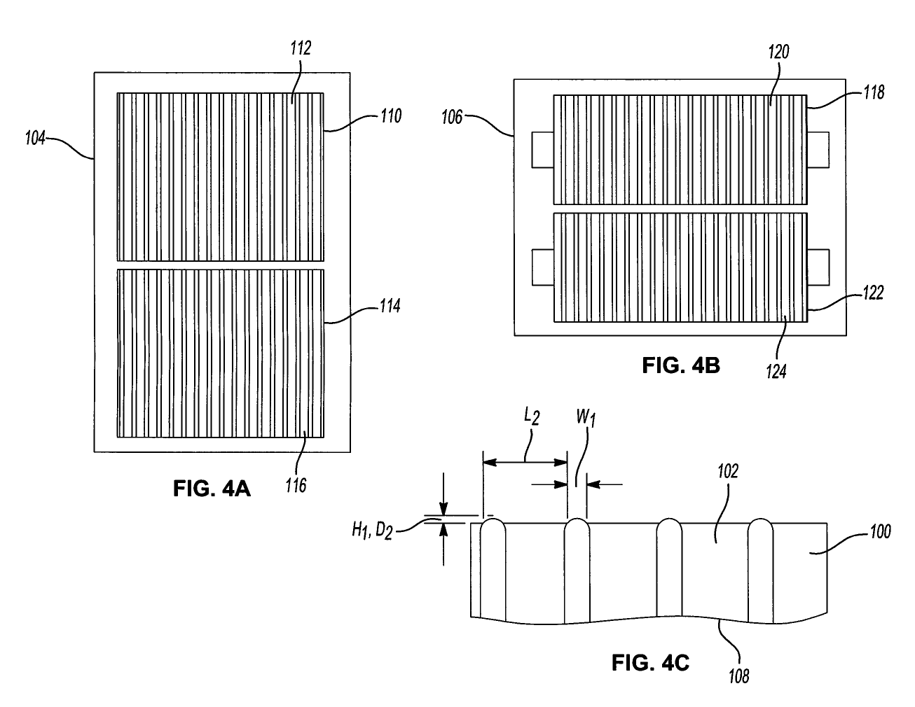

Another method of making a patterned electrode material is depicted in FIGS. 4A-4C. The method comprises contacting a first surface 100 of an electrode material 102 with a first surface of a first pressing element of a flat press 104 or of a roll press 106 and contacting a second opposing surface 108 of the electrode material 102 with a second surface of a second pressing element of the flat press 104 or of the roll press 106. For example, FIG. 4A shows the flat press 104 having a first flat pressing plate 110 (a first pressing element) having a first pressing surface 112 and a second flat pressing plate 114 (a second pressing element) having a second pressing surface 116. And FIG. 4B shows the roll press 106 having a first cylindrical pressing roll or calender 118 (a first pressing element) having a first pressing roll surface 120 and a second cylindrical pressing roll or calender 122 (a second pressing element) having a second pressing roll surface 124. The first surface 112, 120 of the first pressing element 110, 118 defines a first concave (i.e., engraved or grooved) or convex (i.e., raised) pattern and the second pressing surface 116, 124 of the second pressing element 114, 122 defines a second concave or convex pattern.

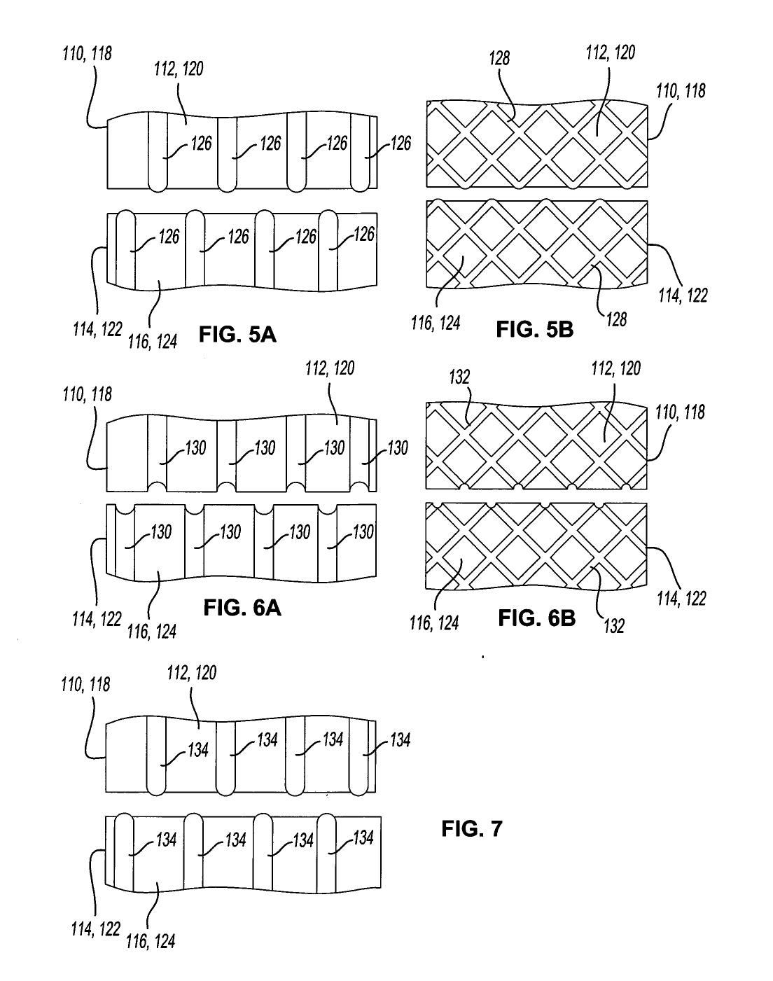

FIGS. 5A and 5B show exemplary first pressing surfaces 112, 120 of the first pressing elements 110, 118, and second pressing surfaces 116, 124 of the second pressing elements 114, 122. In FIG. 5A, the first pressing surfaces 112, 120 of the first pressing elements 110, 118 and the second pressing surface 116, 124 of the second pressing element 114, 122 comprises convex patterns comprising a plurality of convex stripes 126, which may be, for example, semi-circular, square, rectangular, or triangular. The convex stripes 126 can be aligned between the first pressing surface 112, 120 and the second pressing surface 116, 124 or the convex stripes 126 can be offset from each other between the first pressing surface 112, 120 and the second pressing surface 116, 124 as shown in the figure. The convex stripes 126 can be parallel or substantially parallel as described above.

In FIG. 5B, the first pressing surfaces 112, 120 of the first pressing elements 110, 118 and the second pressing surface 116, 124 of the second pressing element 114, 122 comprises convex patterns comprising a convex grid 128. The convex grid 128 comprises interconnecting convex lines that define a repeating geometric pattern between the lines, wherein the convex lines may be, for example, semi-circular, square, rectangular, or triangular. The repeating geometric pattern may be, as non-limiting examples, squares, rectangles, triangles, diamonds, or combinations thereof. The convex grid 128 can be aligned between the first pressing surface 112, 120 and the second pressing surface 116, 124 or the convex grid 128 can be offset from each other between the first pressing surface 112, 120 and the second pressing surface 116, 124 as shown in the figure.

FIGS. 6A and 6B also show exemplary first pressing surfaces 112, 120 of the first pressing elements 110, 118, and second pressing surfaces 116, 124 of the second pressing elements 114, 122. In FIG. 6A, the first pressing surfaces 112, 120 of the first pressing elements 110, 118 and the second pressing surface 116, 124 of the second pressing element 114, 122 comprises concave patterns comprising a plurality of concave stripes 130, which may be, for example, semi-circular, square, rectangular, or triangular. The concave stripes 130 can be aligned between the first pressing surface 112, 120 and the second pressing surface 116, 124 or the concave stripes 130 can be offset from each other between the first pressing surface 112, 120 and the second pressing surface 116, 124 as shown in the figure. The concave stripes 130 can be parallel or substantially parallel as described above.

In FIG. 6B, the first pressing surfaces 112, 120 of the first pressing elements 110, 118 and the second pressing surface 116, 124 of the second pressing element 114, 122 comprises concave patterns comprising a concave grid 132. The concave grid 132 comprises interconnecting concave lines that define a repeating geometric pattern between the lines, wherein the concave lines may be, for example, semi-circular, square, rectangular, or triangular. The repeating geometric pattern may be, as non-limiting examples, squares, rectangles, triangles, diamonds, or combinations thereof. The concave grid 132 can be aligned between the first pressing surface 112, 120 and the second pressing surface 116, 124 or the concave grid 132 can be offset from each other between the first pressing surface 112, 120 and the second pressing surface 116, 124 as shown in the figure.

FIG. 7 shows another example of first pressing surfaces 112, 120 of the first pressing elements 110, 118, and second pressing surfaces 116, 124 of the second pressing elements 114, 122. Similar to FIG. 6A, the first pressing surfaces 112, 120 of the first pressing elements 110, 118 and the second pressing surface 116, 124 of the second pressing element 114, 122 comprises concave patterns comprising a plurality of concave stripes. However, metal wires 134 are disposed in the concave stripes, which results in convex stripes similar to FIG. 5A. The metal wires 134 comprise (Cu), aluminum (Al), iron (Fe), nickel (Ni), titanium (Ti), platinum (Pt), palladium (Pd), an alloy, or a combination thereof. The metal wires 134 can be aligned between the first pressing surface 112, 120 and the second pressing surface 116, 124 or the metal wires 134 can be offset from each other between the first pressing surface 112, 120 and the second pressing surface 116, 124 as shown in the figure. The metal wires 134 can be parallel or substantially parallel as described above.

The method further comprises applying pressure to the electrode material 102 through both the first pressing element 110, 118 and the second pressing element 114, 122, wherein the first and second concave or convex patterns are transferred to the first and second surfaces 100, 108 of the electrode material 102 as a three dimensional mirror image or negative to form the patterned electrode material 102. In various aspects of the current technology, the contacting of the first surface 100 of the electrode material 102 with the first surface 112, 120 of the first pressing element 110, 118, the contacting the second opposing surface 108 of the electrode material 102 with the second surface 116, 124 of the second pressing element 114, 122, and the applying pressure are performed simultaneously or substantially concurrently. The amount of pressure applied should be sufficient to transfer the patterns to the electrode material 102 without damaging the electrode material 102. However, it is understood that the more pressure that is applied, the deeper or higher the transferred pattern will be. In various aspects of the current technology, greater than or equal to about 4000 psi to less than or equal to about 30,000 psi of pressure is applied.

In various aspects of the current technology, the method includes heating at least one of the electrode material 102, the first pressing element 110, 118 and the second pressing element 114, 122 to help facilitate engraving the patterns into the electrode material 102. Heating can be performed, for example, at a temperature of greater than or equal to about 50° C. to less than or equal to about 140° C., and is dependent on the electrode material 102 and the composition of the first pressing element 110, 118 and the second pressing element 114, 122.

The method also includes removing the patterned electrode material 102 from the pressing elements 110, 118, 114, 122. As shown in FIG. 4C, the first and second surfaces 100, 108 of the patterned electrode material 102 may comprise concave or convex stripes that are spaced apart from each other by a length L₂ of greater than or equal to about 0.05 mm to less than or equal to about 2 mm and that have a height H₁ (when convex) or a depth D₂, and a width W₁ of greater than or equal to about 2 μm to less than or equal to about 200 μm, or greater than or equal to about 5 μm to less than or equal to about 100 μm.

Although not shown in the figures, it is understood that the current technology contemplates embodiments where the at least one of the first pressing element 110, 118 and the second pressing element 114, 122 does not include a pattern, such that the resulting patterned electrode material has only one surface with a concave or convex pattern. Also, The current technology contemplates embodiments wherein the first pressing element 110, 118 and the second pressing element 114, 122 have different patterns, such that the resulting patterned electrode material has a first pattern on a first surface and a different pattern on an opposing second surface. For example, the first pattern on the first surface may comprise concave stripes and the second pattern on the opposing second surface may comprise a convex grid. Any combination of the patterns described herein may be applied.

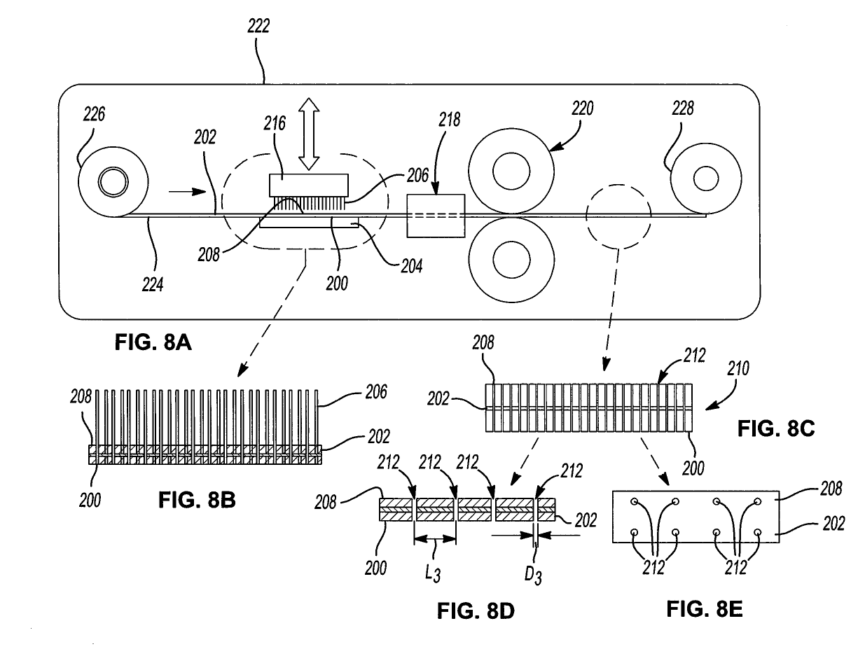

Another method of making a patterned electrode material is depicted in FIGS. 8A-8E. The method comprises disposing a first surface 200 of an electrode material 202 on a first support cushion 204 and contacting a plurality of needles 206 arranged in a pattern to an opposing second surface 208 of the electrode material 202. The support cushion 204 comprises glass, plastic, ceramic, metal, or a combination thereof and provides support for the electrode material 202 during the method. In various aspects of the current technology, the cushion 204 includes a plurality of receiving apertures that are aligned with and receive the plurality of needles 206 during performance of the method.

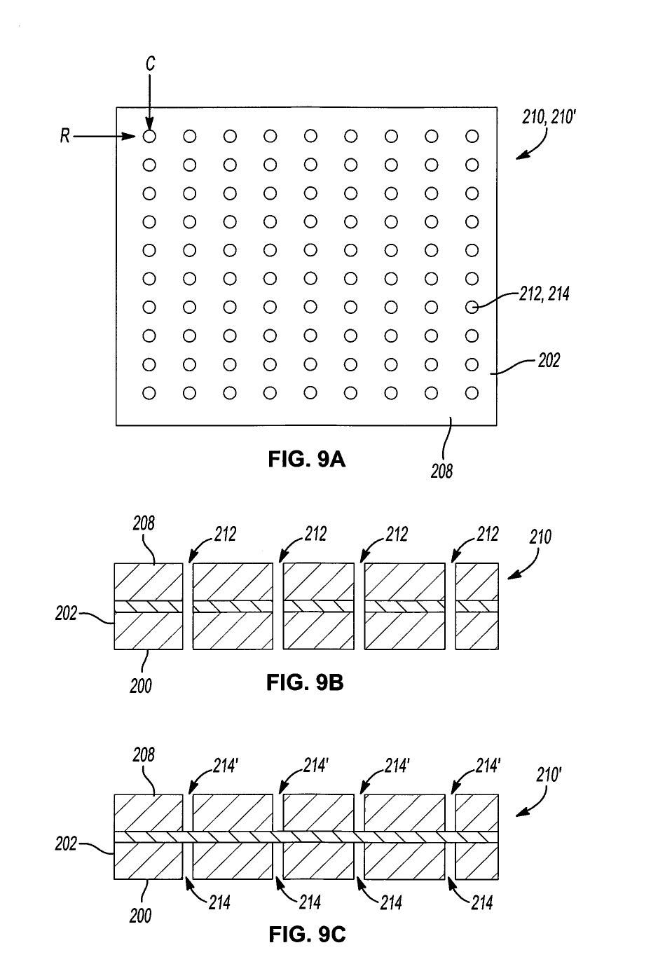

The plurality of needles 206 is coupled to a press plate 216, each needle of the plurality has a diameter D₃ of from greater than or equal to about 2 μm to less than or equal to about 200 μm or greater than or equal to about 5 μm to less than or equal to about 100 μm, is spaced apart from each other by a length L₃ of greater than or equal to about 0.1 mm to less than or equal to about 2 mm, and comprises (Cu), aluminum (Al), iron (Fe), nickel (Ni), titanium (Ti), platinum (Pt), palladium (Pd), an alloy, or combinations thereof. In various embodiments, each needle of the plurality of needles 206 has a cross-sectional geometry of a circle (shown), square, rectangle, diamond, oval or triangle. The plurality of needles 206 can be positioned in aligned columns C and rows R (see FIG. 9A) or then can be positioned in off-set or staggered columns and rows (not shown).

The method further comprises applying pressure the plurality of needles 206, wherein the plurality of needles 206 passes at least partially through the electrode material 202, and removing the plurality of needles 206 from the electrode material 202 to form a patterned electrode material 210 comprising a plurality of through apertures 212 that extends all the way through the electrode material 202 from the second surface 208 to the first surface 200 or a patterned electrode material 210′ comprising a plurality of dead-end apertures 214 that extends partially through, i.e., less than 50% through, the electrode material 202 from the second surface 208 and at least partially through the electrode material 202 towards the opposing first surface 200.

In embodiments where the plurality of needles 206 passes partially through the electrode material, the dead-end apertures 214 in the electrode material 202 extend less than 50%, less than 40%, less than 30%, less than 20%, less than 10%, or less than 5% through the electrode material 202. In such embodiments, the method may also include disposing the second surface 208 of the electrode material 202 on the support cushion 204 (or on a second support cushion; not shown), contacting the plurality of needles 206 to the first surface 200 of the electrode material 202, applying pressure to the plurality of needles 206, wherein the plurality of needles 206 passes partially through (less than 50% through) the electrode material 202, and removing the plurality of needles 206 to form the patterned electrode 210′ comprising a second plurality of dead-end apertures 214′ that extends from the first surface 200 and partially through the electrode material 202 towards the second surface 208, wherein the first plurality of dead-end apertures 214 does not communicate with the second plurality of dead-end apertures 214′.

After the plurality of apertures 212, 214, 214′ has been generated in the electrode material 202, the method comprises removing electrode debris from the patterned electrode material 210, 210′, such as, for example, by vacuuming, brushing, or blowing with air, and optionally flattening the pattered electrode material 210, 210′ by passing it through a press, such as a roll press 220 (which allows for a continuous manufacturing process) or a flat press (not shown).

As noted above, the current method can be performed in a continuous process by employing a system 222, which is shown in FIG. 8A. In the system 222, the process includes progressing a sheet of the electrode material 202 along a processing path 224 from a first upstream end 226, which may be a first wheel, to a second downstream end 228, which may be a second wheel. The cushion 204 is located on the processing path 224 and the plurality of needles 206 is located opposite of the cushion 204. A motor (not shown) moves the plurality of needles 206 coupled to the press plate 216 towards the cushion 204 and away from the cushion 204 as shown by the block arrow (either vertically or horizontally depending on the orientation of the system 222). Along the processing path 224, downstream of the cushion 204 and the plurality of needles 206, is a debris cleaning station 218. The debris cleaning station 218 is equipped to vacuum, brush, blow, or otherwise remove debris off of the electrode material 202. Downstream of the debris cleaning station 218 is the roll press 220, which flattens the electrode material 202.

In embodiments where the plurality of needles 206 are configured to generate the first plurality of dead-end apertures 214 in the electrode material 202, the system 222 may include a second cushion and a second plurality of needles (not shown) downstream of the cushion 204 and plurality of needles 206 and upstream of the debris cleaning station 218, but also in an opposite orientation, that allows for the second surface 208 of the electrode material to receive the second plurality of needles to form the second plurality of dead-end apertures 214′.

The system 222 generates a continuous sheet of patterned electrode material 210, 210′, which may then be cut to a size for insertion into a battery or capacitor or otherwise further processed.

FIGS. 9A-9C show schematics of the patterned electrode material 210, 210′. In particular, FIG. 9A shows a top view of the patterned electrode material 210, 210′, in which the columns C and rows R of apertures 212, 214 are aligned. However, as noted above, it is understood that the columns C and rows R may be staggered or off-set (not shown). FIG. 9B is a cross-sectional view of the patterned electrode material 210 having the plurality of through apertures 212 and FIG. 9C is a cross-sectional view of the patterned electrode material 210′ having the plurality of dead-end apertures 214, 214′.

In various other aspects of the current technology, an electrode material is passed through rollers or calenders of a roll press, wherein the rollers or calenders comprise a plurality of protrusions, i.e., small needles, or a plurality of dimples, such that when the electrode material is passed through the rollers or calenders, either the plurality of protrusions generates a plurality of dimples or dead-end apertures in the electrode material of the plurality of dimples generates a plurality of bumps on the electrode material. Therefore, the system 222 of FIG. 8A can be modified in this manner.

The current technology also provides electrochemical cells and capacitors comprising electrode materials, anodes and/or cathodes, made according to all of the above methods.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of making a patterned electrode material, the method comprising:
disposing a first mask comprising a first pattern on a first surface of an electrode material;
disposing a second mask comprising a second pattern on an opposing second surface of the electrode material;
applying pressure through both the first mask and the second mask towards the electrode material, wherein the first pattern of the first mask is engraved into the first surface of the electrode material and the second pattern of the second mask is engraved into the second surface of the electrode material; and
removing the first mask and the second mask from the electrode material to form the patterned electrode material.

2. The method according to claim 1, wherein the first mask and the second mask individually comprises a plurality of wires that defines at least one of the first pattern and the second pattern or a mesh sheet that defines at least one of the first pattern and the second pattern.

3. The method according to claim 2, wherein each wire in the plurality of wires is spaced substantially parallel to each other at a length of greater than or equal to about 0.05 mm to less than or equal to about 2 mm.

4. The method according to claim 2, wherein each wire in the plurality of wires is cylindrical and has a diameter of greater than or equal to about 5 μm to less than or equal to about 200 μm.

5. The method according to claim 2, wherein the mesh sheet defines a repeating pattern of squares, rectangles, triangles, diamonds, or combinations thereof.

6. The method according to claim 1, wherein the first mask and the second mask individually comprise copper (Cu), aluminum (Al), iron (Fe), nickel (Ni), titanium (Ti), platinum (Pt), palladium (Pd), an alloy, or combinations thereof.

7. The method according to claim 1, wherein the at least one of the first mask and the second mask is coated with a polymer or a ceramic.

8. The method according to claim 1, wherein the applying pressure is performed by pressing both the first and second masks into the electrode material between cylindrical calenders of a roll press or between plates of a flat press.

9. The method according to claim 8, further comprising:
heating at least one of the electrode material and either the cylindrical calenders or the plates.

10. An electrochemical cell comprising a patterned electrode material made according to the method of claim 1.

11. A method of making a patterned electrode material, the method comprising:
contacting a first surface of an electrode material with a first surface of a first pressing element of a flat press or roll press, wherein the first surface of the first pressing element defines a first concave or convex pattern;
contacting a second opposing surface of the electrode material with a second surface of a second pressing element of the flat press or roll press, wherein the second surface of the second pressing element defines a second concave or convex pattern;
applying pressure to the electrode material through both the first and second pressing elements, wherein the first and second concave or convex patterns are transferred to the first and second surfaces of the electrode material as a negative and form the patterned electrode material; and
removing the patterned electrode material from the pressing elements.

12. The method according to claim 11, wherein the first and second pressing elements are flat pressing plates of a flat press or cylindrical pressing rolls of a roll press.

13. The method according to claim 11, wherein the contacting a first surface of an electrode material with a first surface of a first pressing element, the contacting a second opposing surface of the electrode material with a second surface of a second pressing element, and the applying pressure are performed substantially concurrently.

14. The method according to claim 11, wherein the first and second concave or convex patterns are individually a plurality of substantially parallel stripes or a grid of interconnecting lines that define a repeating geometric pattern between the lines, wherein the repeating geometric pattern comprises squares, rectangles, triangles, diamonds, or combinations thereof.

15. The method according to claim 11, further comprising;
heating at least one of the electrode material, the first surface of the first pressing element, and the second surface of the second pressing element.

16. A method of making a patterned electrode material, the method comprising:
disposing a first surface of an electrode material on a support cushion;
contacting a plurality of needles arranged in a pattern to an opposing second surface of the electrode material;
applying pressure to the plurality of needles, wherein the plurality of needles passes at least partially through the electrode material; and.
removing the plurality of needles from the electrode material to form a patterned electrode material comprising a plurality of apertures that extends from the second surface and at least partially through the electrode material towards the first surface.

17. The method according to claim 16, wherein the needles pass partially through the electrode material to form a first plurality of apertures, and the method further comprises:
disposing the second surface of the electrode material on the support cushion;
contacting the plurality of needles with the first surface of the electrode material;
applying pressure to the plurality of needles, wherein the plurality of needles passes partially through the electrode material; and
removing the plurality of needles to form the patterned electrode comprising a second plurality of apertures that extends from the first surface and partially through the electrode material towards the second surface, wherein the first plurality of apertures does not communicate with the second plurality of apertures.

18. The method according to claim 16, wherein the support cushion comprises glass, plastic, ceramic, metal, or a combination thereof.

19. The method according to claim 16, wherein the plurality of needles is coupled to a press plate, each needle of the plurality has an average diameter of greater than or equal to about 5 μm to less than or equal to about 100 μm, is spaced apart from each other by greater than or equal to about 0.1 mm to less than or equal to about 2 mm, and comprises copper (Cu), aluminum (Al), iron (Fe), nickel (Ni), titanium (Ti), platinum (Pt), palladium (Pd), an alloy, or combinations thereof.

20. The method according to claim 16, further comprising:
removing electrode material debris from the electrode material; and
flattening the patterned electrode material by passing the patterned electrode material through a roll press.
